(19) United States
(12) Patent Application Publication
(10) Pub. No.: US 2025/0122846 A1
(43) Pub. Date: Apr. 17, 2025

(54) ENGINE DATA PROCESSOR, INTERNAL COMBUSTION ENGINE AND COMPUTER IMPLEMENTED METHOD FOR SETTING A POWERSHIFT RESERVE

(71) Applicant: Rolls-Royce Solutions GmbH, Friedrichshafen (DE)

(72) Inventor: Daniel Bergmann, Bad Wurzach (DE)

(73) Assignee: Rolls-Royce Solutions GmbH, Friedrichshafen (DE)

(21) Appl. No.: 18/912,905

(22) Filed: Oct. 11, 2024

(30) Foreign Application Priority Data
Oct. 13, 2023 (DE) 10 2023 004 151.3

(51) Int. Cl. F02D 41/02

(52) U.S. Cl. CPC F02D 41/0215; F02D 2200/1002; F02D 2250/26

(57) ABSTRACT

An engine data processor for setting a powershift reserve for an internal combustion engine includes: a control unit to adhere to a torque-limiting operating limit value and including a control target; a powershift reserve module for determining the powershift reserve for the torque-limiting operating limit value, the powershift reserve module to: receive a torque setpoint, a powershift reserve setpoint, the torque-limiting operating limit value, and an operating variable; generate an output signal from the torque setpoint, the powershift reserve setpoint, the torque-limiting operating limit value, and the operating variable which have been received; and issue the output signal to the control unit; wherein the control unit is to: adjust the control target by taking into account the output signal, so that the powershift reserve corresponds with the powershift reserve setpoint; and determine a control variable for the internal combustion engine; issue the control variable for the internal combustion engine.

### CROSS REFERENCE TO RELATED APPLICATIONS

This claims priority to German patent application no. 10 2023 004 151.3, filed Oct. 13, 2023, which is incorporated herein by reference.

### BACKGROUND OF THE INVENTION

### 1. Field of the Invention

The present invention relates to an engine data processor.

### 2. Description of the Related Art

Internal combustion engines are often equipped with control systems. The control systems are used to receive and evaluate sensor data, process it by way of algorithms and therefrom to determine and output control variables. The control variables that are output by a control system usually have the purpose of operating different actuators of the combustion engine within safe limit value ranges. The limit value ranges can, for example, define a permissible temperature range or a permissible pressure range.

Internal combustion engines are used in vehicles as drive systems or in buildings in combination with a generator as a power supply unit. In an internal combustion engine, supplied fuel is burned to provide mechanical power. This power can be used to drive a vehicle or a generator.

In numerous applications, the requirements for internal combustion engines include, in addition to meeting emission specifications and operation at optimum cost, also the ability to provide increased mechanical power within the shortest possible response times. The power reserve required for this is called the powershift reserve.

In known internal combustion engines, powershift reserves are not specified directly, but for example through a combined formulation of a target torque, a target consumption, a target air mass flow and a maximum permissible exhaust gas emission limit value.

Thus, a disadvantage of the known internal combustion engines is that the powershift reserve is specified indirectly over several variables, which is time-consuming, associated with high costs and can lead to irreversible damage to the internal combustion engine if the necessary expertise is lacking.

What is needed in the art is a cost effective, safe and flexible configuration of internal combustion engines.

### SUMMARY OF THE INVENTION

The current invention relates to an engine data processor for setting a power shift reserve. It also relates to a computer implemented method for the adjustment of a powershift reserve.

An engine data processor for setting a powershift reserve for an internal combustion engine includes:
a control unit to adhere to a at least one torque-limiting operating limit value, wherein the control unit has at least one control target;
a powershift reserve module for determining the powershift reserve for the at least one torque-limiting operating limit value, wherein the powershift reserve module is designed:
   to receive a torque setpoint, a power-shift reserve setpoint, at least one torque-limiting operating limit value, and at least one operating variable; and
   to generate an output signal from received values, namely, the torque setpoint, the power-shift reserve setpoint, the at least one torque-limiting operating limit value, and the at least one operating variable; and
   to issue the output signal to the control unit;
wherein the control unit is designed:
   to adjust the at least one control target by taking into account the output signal, so that the powershift reserve corresponds with the powershift setpoint; and
   to determine and to issue at least one control variable for the internal combustion engine.

The engine data processor according to the present invention serves to set a powershift reserve in an internal combustion engine. The powershift reserve describes the ability to perform an instantaneous increase in power from a first engine power to a second engine power within the shortest possible period of time. Instantaneous power increases are often required to varying degrees depending on the specific application. From beginning to end of the changeover, instantaneous power increases take no longer than 0.1 to 0.3 seconds.

The engine data processor includes a control unit to adhere to the at least one torque-limiting operating limit value, wherein the control unit has at least one control target. Controllers are characterized by at least one target variable, which is regulated with the assistance of at least one control variable. Inputting or selecting a new control target can optionally cause an adjustment of control variables in the controller.

The engine data processor moreover includes a powershift reserve module for determining the powershift reserve for at least one torque-limiting operating limit value. The powershift reserve module can be assigned to the controller. A torque-limiting operating limit value is a limit value upon which the amount of torque that can be provided by an engine or an internal combustion engine during operation depends. A torque-limiting operating limit value can be, for example, a maximum exhaust gas emission value of an internal combustion engine. A powershift reserve can be determined for a number of torque-limiting operating limit values. This means that the determined powershift reserve can be provided by adhering to the considered operating limit values.

The powershift reserve module is designed to receive a torque setpoint, a powershift reserve setpoint, at least a torque-limiting operating limit value, and at least one operating variable.

The torque setpoint is a current setpoint for a torque that is to be provided by an internal combustion engine, for example, according to a torque request issued by an engine application system.

The powershift reserve setpoint is optionally a powershift reserve value that is required during the operation of an internal combustion engine based on application-specific requirements. In different applications of an internal combustion engine, the powershift reserve setpoint can have different values.

The at least one operating variable is a physical variable, the value of which helps to determine whether an internal combustion engine is in a safe operating mode. The operating variable can, for example, be measured and be available optionally as a received value or measured value.

The powershift reserve module is moreover designed to generate an output signal from the torque setpoint, the powershift reserve setpoint, the at least one operating limit value and the at least one operating variable and to issue the output signal to the controller, wherein the controller is designed to adjust the control target by taking into account the output signal so that the powershift reserve corresponds to the powershift reserve setpoint, and to determine and issue at least one control variable for the internal combustion engine.

By adjusting the control target, the controller can advantageously not only perform the adjustment of the powershift reserve, but also monitor its compliance.

The application specific configuration of machines is simplified by the adjustability of the powershift reserve setpoint of the inventive engine data processor. The simplified setting of powershift reserves increases the flexibility with regard to possible applications for internal combustion engines that are operatively connected with the engine data processor according to the present invention. In setting the powershift reserve by considering at least one torque-limiting operating limit value, the expertise required in regard to the assemblies of the internal combustion engine to be adjusted is advantageously reduced, which also reduces effort and costs.

The inventive solution can be further improved by various designs, each advantageous in itself and arbitrarily combinable with each other. This arrangement and the therewith associated advantages are discussed below. The advantages described with respect to the engine data processor and the internal combustion engine also apply to the computer-implemented method according to the present invention and vice versa.

According to a first possible arrangement, the at least one torque-limiting operating limit value includes a minimum air mass flow value, a minimum combustion air ratio value, a maximum pressure value, a maximum fuel mass flow value, a maximum exhaust gas emission value, a maximum exhaust gas temperature and/or a maximum engine speed value. These variables play a significant role in determining the torque that can be provided by an internal combustion engine and facilitate the determination of a particularly robust powershift reserve. This increases the number of applications for which the internal combustion engine is suitable.

According to an advantageous arrangement, the output signal includes a penalty term, which can be included in the control target of the controller in such a way that the powershift reserve corresponds to the powershift reserve setpoint. This simplifies the integration of the powershift reserve into the controller's control target and increases the accuracy of the powershift reserve set by the controller, further increasing the robustness and operational reliability of internal combustion engines that are operatively connected with the engine data processor.

In another advantageous arrangement, the powershift reserve is designed as a torque shift reserve. This facilitates adjustment of an increase in torque from a first torque to a second torque, which may be required in special applications.

According to another advantageous arrangement, the engine data processor includes a setpoint data interface for receiving the powershift reserve setpoint and at least one torque-limiting operating limit value, an operating variable data interface for receiving at least one operating variable, and a data memory for reading out the torque setpoint. This arrangement simplifies the design of the engine data processor as a self-contained and cost-effective unit with which existing internal combustion engines can be equipped.

The present invention also provides an internal combustion engine, wherein the internal combustion engine includes an engine data processor according to one of the above designs, wherein the powershift reserve can be provided by way of the at least one control variable output by the engine data processor.

The internal combustion engine according to the present invention benefits from the already described advantages of the engine data processor through increased flexibility with regard to applications with high demands on the powershift reserve to be provided by the internal combustion engine. The simplified adjustability of the powershift reserve reduces the operating and configuration costs of the internal combustion engine and simplifies its conversion to other applications. Setting of the powershift reserve can advantageously occur completely in the engine data processor and thus internally in the combustion engine. The connection of the internal combustion engine to an external computing unit is possible, but not mandatory.

The present invention also provides a computer-implemented method according to claim 7.

The computer implemented method for setting the powershift reserve for an internal combustion engine according to the present invention includes the following steps:
Receiving at least one torque-limiting operating limit value, a powershift reserve setpoint, at least one operating variable and one torque setpoint,
Determining a powershift reserve for at least one operating limit value,
Generating and issuing a penalty term to correct deviations from the powershift reserve setpoint, and
Generating and issuing one or more control variables for an internal combustion engine, taking into account the issued penalty term.

All process steps can be performed by the engine data processor according to the present invention, thus being able to implement the method cost-effectively.

The method moreover simplifies setting of powershift reserves in that it represents a possibility for direct input of an application-based powershift reserve for an internal combustion engine via the direct input of a powershift reserve setpoint.

Alternatively, or additionally, the process steps can be performed, at least in part, by the external computing unit mentioned above or by an external multi-purpose computer.

The present invention is discussed in further detail below, with reference to the drawings.

The combination of features is presented by way of example in the embodiments shown and can be supplemented by further features in accordance with the above explanations according to the properties of the engine data processor according to the present invention and/or the internal combustion engine according to the present invention, as necessary for a specific application.

According to the above explanations, individual features may also be omitted if the effect of said feature in a specific application is not decisive.

The same reference signs are used in the drawings for elements fulfilling the same function and/or having the same structure.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of an engine data processor according to one exemplary embodiment;

FIG. 2 is a schematic representation of an internal combustion engine according to one exemplary embodiment;

FIG. 3 is a progression of a powershift reserve setpoint and a powershift reserve depending on time; and

FIG. 4 is schematic representation of a computer implemented method for setting a powershift reserve for an internal combustion engine.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

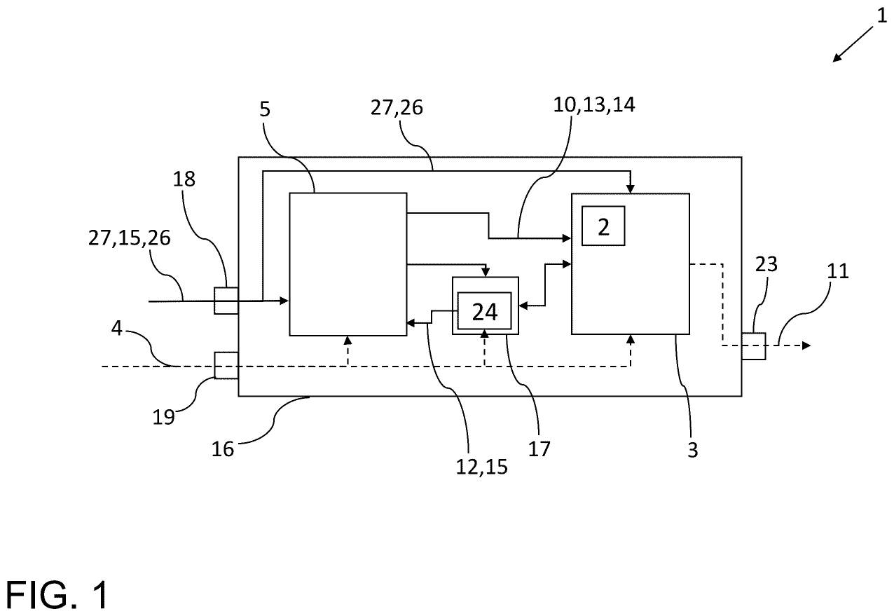

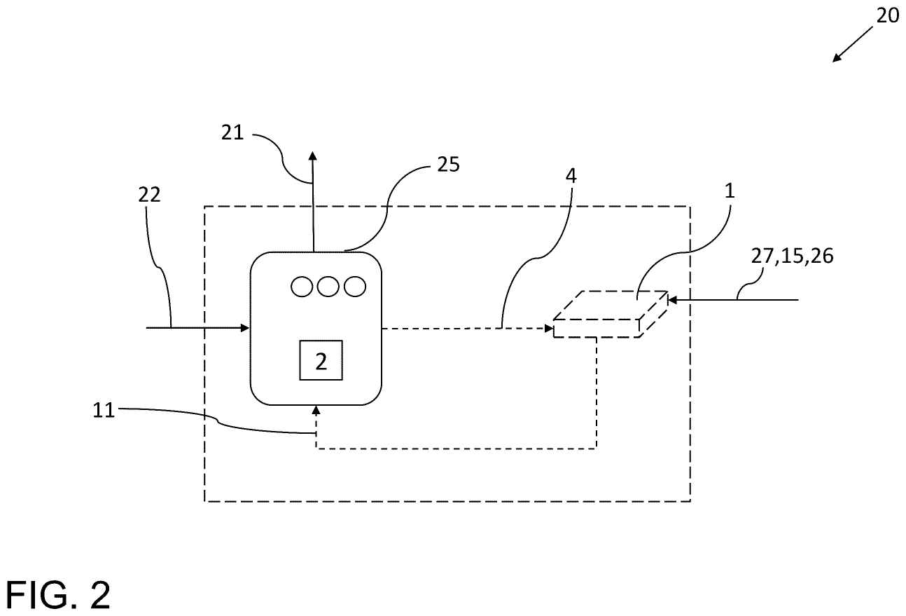

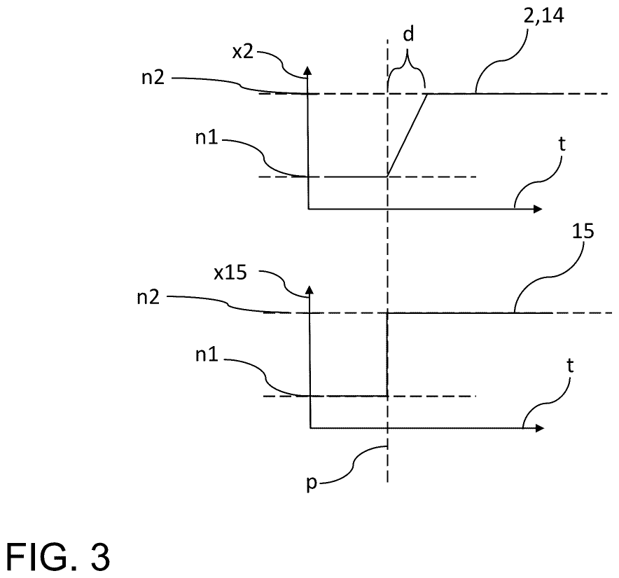

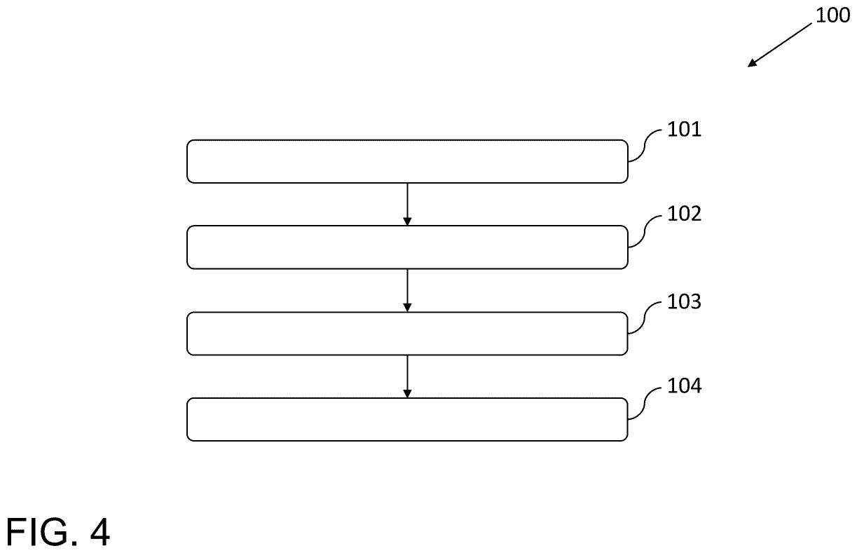

The following describes an engine data processor 1 for setting a powershift reserve 2 according to the invention with reference to FIG. 1. Also described on the basis of FIG. 2 is an internal combustion engine 20 according to the invention, a curve progression of powershift reserve 2 over time t on the basis of FIG. 3 and a method 100 according to the present invention on the basis of FIG. 4.

FIG. 1 shows a simplified, schematic representation of engine data processor 1. Engine data processor 1 can have a standalone processor board 16 and/or be integrated on a board of internal combustion engine 20 (not shown). The units, blocks, and modules of engine data processor 1 described below can be implemented respectively in hardware, software, or a combination of both.

Engine data processor 1 is intended for setting a powershift reserve 2 for an internal combustion engine and includes a controller 3 to adhere to at least one torque-limiting operating limit value 26. Torque-limiting operating limit value 26 is a limit value on which the amount of torque that can be provided during operation by an engine or an internal combustion engine depends.

Controller 3 includes at least one control target 27. Control target 27 can advantageously be designed as a fuel consumption function for the adjustment of an internal combustion engine operation by adhering to torque-limiting operating limit values 26 and low fuel consumption values.

Torque-limiting value 26 and control target 27 can for example be received via a setpoint data interface 18.

Engine data processor 1 moreover includes a powershift reserve module 5 for determination of powershift reserve 2 for at least one torque-limiting operating limit value 27. Powershift reserve module 5 can be assigned to controller 3.

Torque limiting operating limit value 26 may for example be a maximum exhaust gas value 28 of an internal combustion engine which is received by engine data processor 1 at setpoint data interface 18. Powershift reserve 2 can be determined for numerous torque-limiting operating limit values 26. This means that determined powershift reserve 2 is provided by adhering to considered operating limit values 26.

Powershift reserve module 5 is designed to receive a torque setpoint 12, a powershift reserve setpoint 15, at least one torque-limiting operating limit value 26, and at least one operating variable 4.

Torque setpoint 12 is a current setpoint for a torque that is to be provided by an internal combustion engine, for example, according to a torque request sent by an engine application system (not shown).

Powershift reserve setpoint of 15 is optionally a powershift reserve value that is required during the operation of an internal combustion engine due to the application-specific requirements. The powershift reserve setpoint can exhibit different values in different applications of an internal combustion engine.

The at least one operating variable 4 is a physical variable or a parameter whose value aids in determining whether an internal combustion engine is in a safe operative state. Operating variable 4 can, for example, be measured and is optionally a received value or measured value. Operating variable 4 includes optionally a current air mass flow value, a current pressure value, a fuel mass flow value, and/or an engine speed value.

Moreover, powershift reserve module 5 is designed to generate an output signal 10 from torque setpoint 12, from powershift reserve setpoint 15, from the at least one operating limit value 26 and from the at least one operating variable 4 and to issue output signal 10 to controller 3, wherein controller 3 is designed, to adjust control target 27 by taking into account the output signal 10 in such a way that powershift reserve 2 corresponds to powershift reserve setpoint 15, and to determine and issue at least one control variable of 11 for an internal combustion engine.

By adjustment of control target 27, controller 3 can advantageously not only perform setting of powershift reserve 2 but can also monitor its compliance.

According to a first possible arrangement, the at least one torque-limiting operating limit value 26 includes a minimum air mass flow value, a minimum combustion air ratio value, a maximum pressure value, a maximum fuel mass flow value, a maximum exhaust gas emission value, a maximum exhaust gas temperature and/or a maximum engine speed value. The pressure value can advantageously be the pressure of charge air that is pumped into the combustion chamber of an internal combustion engine prior to combustion. Alternatively, the pressure value can correspond to the pressure at which a fuel combustion process occurs in the internal combustion engine. Torque-limiting operating limits 26 play a significant role in determining the torque that can be provided by an internal combustion engine and facilitate determination of an especially robust powershift reserve 2. This increases the number of applications for which an internal combustion engine equipped with engine data processor 1 is suitable.

According to one advantageous arrangement, output signal 10 includes a penalty term 13, which can be included into control target 27 of controller 3 such that powershift reserve 2 corresponds to powershift reserve setpoint 15. This simplifies integration of powershift reserve 2 into the controller's control target 27 and increases the accuracy of powershift reserve 2 set by controller 3, further increasing the robustness and operational reliability of the internal combustion engines which are operationally connected with engine data processor 1.

In another advantageous arrangement, powershift 2 is designed as a torque shift reserve 14. This facilitates setting of a torque increase from a first torque to a second torque, which may be necessary for specific application.

According to another advantageous arrangement, engine data processor 1 includes—in addition to setpoint data interface 18 for receiving powershift reserve setpoint 15 and the at least one torque-limiting operating limit 26—an operating variable data interface 19 for receiving at least one operating variable 4, and a data memory 17 for reading out torque setpoint value 12. This configuration simplifies the design of engine data processor 1 as a stand-alone and cost-effective unit with which existing internal combustion engines can be equipped.

Engine data processor 1 optionally includes an output data interface 23 which is designed to output one or numerous control variables 11.

Data memory 17 has, for example, a torque model designed as a lookup table 24. By way of lookup table 24, torque setpoint 12 can—for example depending on one or more operating variables 4—be determined and retrieved from powershift reserve module 5. In an advantageous arrangement, data storage 17 can have at least one preset powershift reserve setpoint of 15.

FIG. 2 shows a schematic representation of internal combustion engine 20 according to the present invention. Internal combustion engine 20 includes an engine data processor 1 according to one of the above designs, wherein powershift reserve 2 can be provided by way of at least the one control variable 11 output by engine data processor 1.

Fuel 22 fed into engine 25 is burned in internal combustion engine 20, thereby providing mechanical power 21. Mechanical power 21 is characterized by a torque and speed used to drive a consuming system (not shown). The consuming system can advantageously be a machine, a vehicle or a generator.

Internal combustion engine 20 according to the present invention benefits from the already described advantages of engine data processor 1, offers increased flexibility with regard to applications with demands on powershift reserve 2 that is to be provided by internal combustion engine 20.

FIG. 3 shows a curve progression of powershift reserve 2 that is set by engine data processor 1 and provided by internal combustion engine 20 (see FIG. 3, top) subject to powershift reserve setpoint 15 (see bottom on FIG. 3).

The lower curve progression (bottom of FIG. 3) shows the progression of powershift reserve setpoint 15, subject to time t. At a point in time p, for example, an initial value of power shift reserve setpoint 15,n1 is increased to a new powershift reserve setpoint 15,n2 by entering a new powershift reserve setpoint 15. New powershift reserve setpoint 15,n2 is for example entered into engine data processor 1 by a user (not shown).

The upper curve progression (FIG. 3, top) shows how current powershift reserve 2 and powershift reserve setpoint value is at 15,n1 until time p and starts to increase subject to new powershift reserve setpoint value 15,n2 at time point p. With a time delay d, powershift reserve 2 is adapted to new value n2 of powershift reserve setpoint 15. With expiration of time delay d, powershift reserve 2 corresponds with powershift reserve setpoint 15. In the present example, powershift reserve 2 as well as powershift reserve setpoint are at 15,n2.

The simplified adjustability of powershift reserve 2 reduces operating and configuration costs of internal combustion engine 20 and simplifies its conversion to other applications. Setting of powershift reserve 2 can advantageously be done completely in engine data processor 1 and thus in internal combustion engine 20. Connection of internal combustion engine 20 to an external computing device is possible, but not mandatory.

FIG. 4 shows a computer-implemented method 100 for setting a powershift reserve 2 for an internal combustion engine. Computer-implemented procedure 100 includes the following steps:
Step 101: receiving at least one torque-limiting operating limit value 26, a powershift reserve setpoint 15, at least one operating variable (4) and a torque setpoint 12;
Step 102: determining a powershift reserve 2 for at least one torque-limiting operating limit value 26;
Step 103: generating and outputting a penalty term 13 for correction of deviations of powershift reserve 2 from powershift reserve setpoint 15; and
Step 104: generating and outputting one or numerous control variables 11 for an internal combustion engine by taking into account issued penalty term 13.

All process steps can be carried out by inventive engine data processor 1. Consequently, method 100 can be implemented cost-effectively and automatically.

Method 100 moreover simplifies setting of powershift reserves 2, in that it provides a possibility to directly input a new, application-specific powershift reserve 2 for an internal combustion engine via the direct input of powershift reserve setpoint 15.

Alternatively, or in addition, the process steps can be carried out, at least in part, by the above referenced external computing unit or by an external multi-purpose computer.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An engine data processor for setting a powershift reserve for an internal combustion engine, the engine data processor comprising:
a control unit structured and arranged to adhere to at least one torque-limiting operating limit value, the control unit including at least one control target;
a powershift reserve module structured and arranged for determining the powershift reserve for the at least one torque-limiting operating limit value, the powershift reserve module being structured and arranged to:
receive a torque setpoint, a powershift reserve setpoint, the at least one torque-limiting operating limit value, and at least one operating variable;
generate an output signal from the torque setpoint, the powershift reserve setpoint, the at least one torque-limiting operating limit value, and the at least one operating variable which have been received; and
issue the output signal to the control unit;
wherein the control unit is structured and arranged to:
adjust the at least one control target by taking into account the output signal, so that the powershift reserve corresponds with the powershift reserve setpoint; and
determine at least one control variable for the internal combustion engine;
issue the at least one control variable for the internal combustion engine.

2. The engine data processor according to claim 1, wherein the at least one torque-limiting operating limit value includes at least one of a minimum air mass flow value, a minimum combustion air ratio value, a maximum pressure value, a maximum fuel mass flow value, a maximum exhaust gas emission value, a maximum exhaust gas temperature, and a maximum engine speed value.

3. The engine data processor according to claim 1, wherein the engine data processor is structured and arranged such that the output signal includes a penalty term, which is included in the at least one control target of the control unit such that the powershift reserve corresponds to the powershift reserve setpoint.

4. The engine data processor according to claim 1, wherein the powershift reserve is structured and arranged as a torque shift reserve.

5. The engine data processor according to claim 1, further comprising:
a setpoint data interface structured and arranged for receiving the powershift reserve setpoint and the at least one torque-limiting operating limit value;
an operating variable data interface structured and arranged for receiving the at least one operating variable; and
a data memory structured and arranged for reading out the torque setpoint.

6. An internal combustion engine for providing mechanical power, the internal combustion engine comprising:
an engine data processor structured and arranged for setting a powershift reserve for the internal combustion engine, the engine data processor including:
a control unit structured and arranged to adhere to at least one torque-limiting operating limit value, the control unit including at least one control target;
a powershift reserve module structured and arranged for determining the powershift reserve for the at least one torque-limiting operating limit value, the powershift reserve module being structured and arranged to:
receive a torque setpoint, a powershift reserve setpoint, the at least one torque-limiting operating limit value, and at least one operating variable;
generate an output signal from the torque setpoint, the powershift reserve setpoint, the at least one torque-limiting operating limit value, and the at least one operating variable which have been received; and
issue the output signal to the control unit;
wherein the control unit is structured and arranged to:
adjust the at least one control target by taking into account the output signal, so that the powershift reserve corresponds with the powershift reserve setpoint; and
determine at least one control variable for the internal combustion engine;
issue the at least one control variable for the internal combustion engine.

7. The internal combustion engine according to claim 6, wherein the powershift reserve is provided by way of the at least one control variable which is output by the engine data processor.

8. A computer-implemented method for setting a powershift reserve for an internal combustion engine, the computer-implemented method comprising the steps of:
receiving at least one torque-limiting operating limit value, a powershift reserve setpoint, an operating variable, and a torque setpoint;
determining a powershift reserve for the at least one torque-limiting operating limit value;
generating and outputting a penalty term for correcting a deviation of the powershift reserve from the powershift reserve setpoint; and
generating and outputting at least one control variable for the internal combustion engine by taking into account the penalty term that has been issued.
